(19) United States
(12) Patent Application Publication
(10) Pub. No.: US 2011/0147018 A1
(43) Pub. Date: Jun. 23, 2011

(54) TILLAGE BLADE CONFIGURED TO STAY SHARP LONGER

(76) Inventor: Douglas G. BRUCE, Perry, IA (US)

(21) Appl. No.: 12/646,195

(22) Filed: Dec. 23, 2009

(51) Int. Cl. A01B 33/00; A01B 33/16

(52) U.S. Cl. 172/120

(57) ABSTRACT

A tillage blade having a sharpened outer peripheral edge on a blade body has a predetermined thickness. An annular portion of the blade is disposed between the outer peripheral edge and the body having a thickness which is less than the thickness of the body of the blade, the annular portion having a radially outer part and a radially inner part. The blade is tapered from the sharpened peripheral edge to the radially outer part of the annular portion and the blade is tapered from the radially inner part of the annular portion to the body. By making the sharpened bevels on out outer periphery of the blades taper in steps instead of just sharpening them by making either one bevel on one side, or a bevel on each side of the outer periphery of the blade, the blade will last longer than prior art tillage blades.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

### Field of the Invention

Tillage blades are the blades on an agricultural implement that actually contact and till the soil. These blades come in a variety of configurations. One configuration is a circular blade such as a flat coulter or a drill blade that rotates about a center rotational axis. Coulters can be bent into a variety of shapes such as fluted or wavy coulters. Discs are the common name for blades that are like a coulter but that also are bent into a concave/convex shape to penetrate the soil and throw it in one direction. These discs can have a plan circular outer periphery or they can have notches cut out or they can be fluted or wavy.

All of these drill blades, coulters and discs rotate about a center rotational axis and are sharpened at the outer periphery to cause them to cut into the soil and cut debris on the surface of the soil better than if they were not sharpened. As they contact the soil and work the soil the sharpened outer periphery thereof wears off and eventually becomes dull. Typically when they become dull they are considered to be worn out and are replaced rather than re-sharpened, though the later is done in some cases.

A tillage blade of the type referred to above is typically formed from a sheet of steel which has a substantially constant thickness. During the process of making them they are stamped out as circular pieces first and then cut or formed into the desired shape including a sharpened outer peripheral edge. They can have notches cut out in the outer periphery and they can be made concave/convex into a “disc” or made into a fluted or wavy coulter. After that they are heat treated to cause them to be harder so they will wear out slower.

Looking to FIG. 3, the dashed lines show one form of the prior art blades where there is just one sharpened bevel on the outer periphery. The blade of the prior art is considered worn out when it is no longer sharp, for example when the outer periphery of the blade outside of “i” is worn off. Notice that once it is worn to “j” that it would be at the same thickness “a” as the body of the blade. Similarly, Looking to FIG. 3, the dashed lines show one form of the prior art blades where there are two sharpened bevels on the outer periphery. The blade of the prior art in dashed lines in FIG. 3 is considered worn out when it is no longer sharp, for example when the outer periphery of the blade outside of “I” is worn off. Notice that once it is worn to “J” that it would be at the same thickness “A” as the body of the blade.

A problem to be solved is how to make the blades of the prior art last longer.

### BRIEF SUMMARY OF THE INVENTION

The present invention relates to a tillage blade that stays sharp longer than prior art tillage blades. This is done by making the sharpened bevels on out outer periphery of the blades taper in steps instead of just sharpening them by making either one bevel on one side, or a bevel on each side of the outer periphery of the blade.

The tillage blade of the present invention has a sharpened outer peripheral edge on a blade body with a predetermined thickness (a or A). An annular portion of the blade is disposed between the outer peripheral edge and the body having a thickness (b or B) which is less than (a or A), the annular portion having a radially outer part and a radially inner part. The blade is tapered from the sharpened peripheral edge to the radially outer part of the annular portion and the blade is tapered from the radially inner part of the annular portion to the body.

Therefore, an object of the present invention is to provide a tillage blade configured to stay sharp longer than prior art blades of a similar type.

Other objects, advantages, and novel features of the present invention will become apparent from the following detailed description of the invention when considered in conjunction with the accompanying drawings.

### BRIEF DESCRIPTION OF THE SEVERAL VIEWS OF THE DRAWINGS

FIG. 1 is a side view of a preferred embodiment of the present invention for use as a grain drill blade or coulter for other uses;

FIG. 2 is a side view of another preferred embodiment of the present invention for use as a grain drill blade or coulter for other uses;

FIG. 3 is a cross sectional view taken along line 2-2 of FIG. 1; and

FIG. 4 is a cross sectional view taken along line 3-3 of FIG. 2.

### DETAILED DESCRIPTION OF THE INVENTION

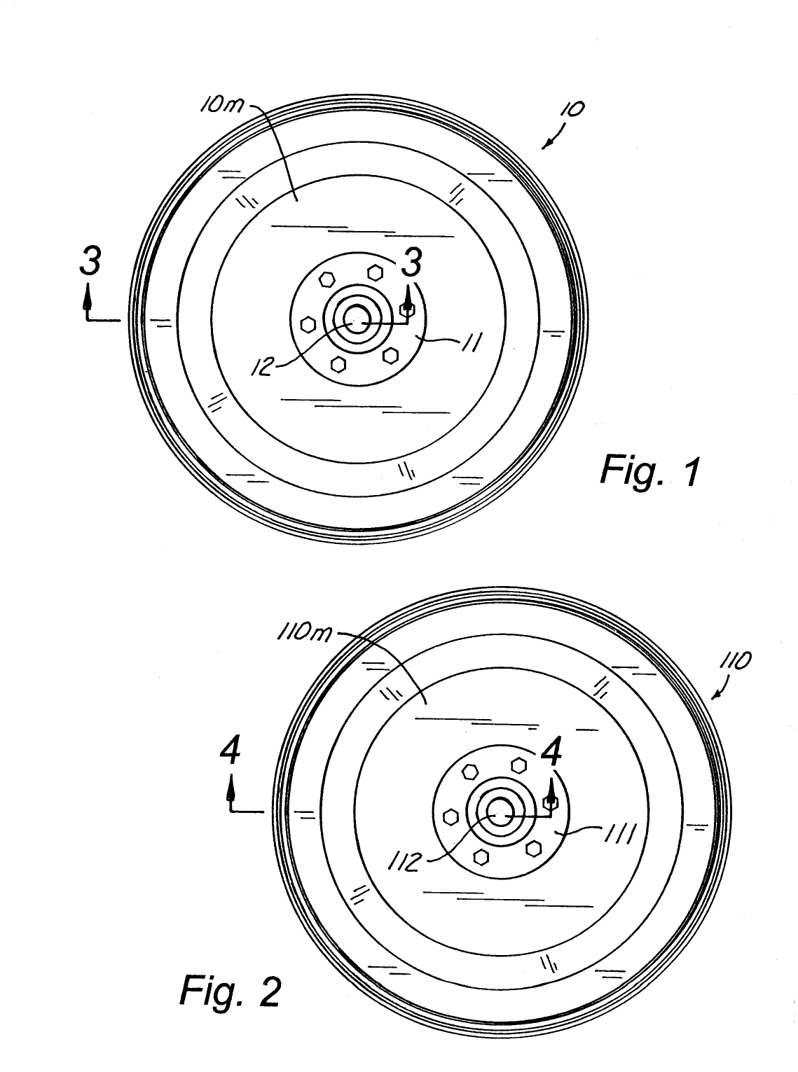

Referring now to the drawings, wherein like reference numerals designate identical or corresponding parts throughout the several views, FIG. 1 shows a grain drill blade (10) constructed in accordance with the present invention. A hub and bearing unit is bolted to the blade (10) so that the blade (10) be attached to a shaft of an implement such as a grain drill (not shown) and can rotate about a rotational axis (12), which axis (12) is shown as a single point in FIG. 1.

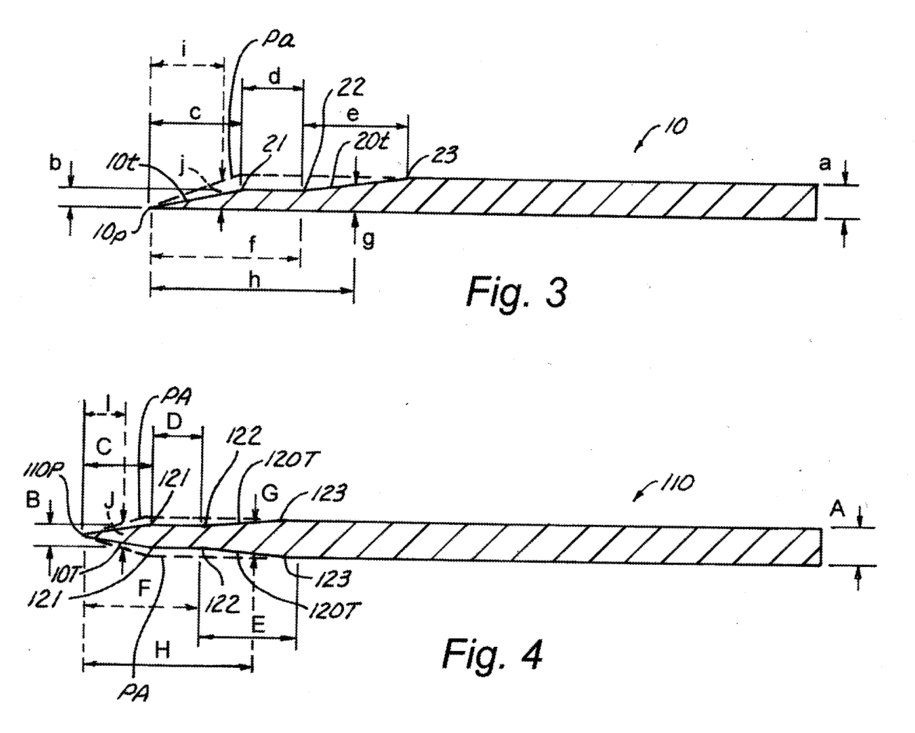

The tillage blade (10) has a main body portion (10m) having first thickness (a or A) as shown in FIGS. 3 and 4 and a sharpened radially outer periphery (10p or 10P).

A first annular surface (10t or 10T) tapers in thickness from the outer periphery thereof to a first radius (21 or 121), the difference in radial distance from the outer periphery (10p) and the first radius (21 or 121) being a distance (c or C respectively).

A second annular surface (20t or 120T) tapers from a second radius (22 or 122) to a third radius (23 or 123), the thickness of the blade (10 or 110) at the third radius (23 or 123) being approximately the thickness (a or A) of the first portion (10m) of the main body portion, the third radius (23 or 123) being greater than the second radius (22 or 122). The thickness (b or B) of the blade at the second radius (22 or 122) is less than the thickness (a or A) of the blade (10 or 110) at the third radius (23 or 123) the difference in radial distance from the second radius (22 or 122) and the third radius (23 or 123) is a distance (e or E). The thickness (b or B) of the blade (10 or 110) at the first radius (21 or 121) is less than the thickness (b or B) of the blade at the second radius (22 or 122).

The thickness (b or B) of the blade at the first radius (21 or 121) is approximately the same as the thickness of the blade (10 or 110) as the thickness of the blade (10 or 110) at the second radius (22 or 122). The radial distance between of the blade (10) at the first radius (21) and the second radius (22 or 122) is a distance (d or D) and the thickness of the blade (10) all of the way between the first radius (21) and the second radius (22 or 122) is approximately the same.

In a preferred embodiment, the thickness (b or B) equals 0.5 to 0.75 times the thickness (a or A respectively) of the body of the blade, the distance (c or C) equals 1.5 to 4 times the thickness (a or A respectively) of the body of the blade (10 or 110), the distance (d or D) equals 1 to 4 times the thickness (a or A respectively) of the body of the blade (10 or 110) and the distance (e or E) equals 2 to 4.5 times the thickness (a or A respectively) of the body of the blade (10 or 110).

Looking to FIG. 3, in dashed lines is the prior art (pa). When the prior art blade (pa) passes through the soil it wears away by a distance (i) from the outer periphery (lop) to approximately (j) the prior art blade (pa) at which point it is considered to be no longer sharp enough to be useful, i.e. it is worn out. Compare this to the instant invention embodiment shown in FIG. 3 wherein the blade (10) is still sharp enough to useful until it reaches approximately point (g), a distance (h) from the outer periphery (10p). Clearly distance (h) is much greater than distance (i) and the blade (10) is also much sharper throughout most of its wear pattern as compared to the prior art (pa) shown in dashed lines in FIG. 3. This illustrates how much improved the present invention shown in solid line in FIG. 3 is over the prior art (pa).

Looking to FIG. 4, in dashed lines is the prior art (PA). When the prior art blade (PA) wears by a distance (I) from the outer periphery (10P) to approximately (J) the prior art blade (PA) is considered to be no longer sharp enough to be useful, i.e. it is worn out. Compare this to the instant invention embodiment shown in FIG. 4 wherein the blade (110) is still sharp enough to useful until it reaches approximately point (G), a distance (H) from the outer periphery (110p). Clearly distance (H) is much greater than distance (I) and the blade (110) is also much sharper throughout most of its wear pattern as compared to the prior art (PA) shown in dashed lines in FIG. 4. This illustrates how much improved the present invention shown in solid lines in FIG. 4 is over the prior art (PA).

Obviously many modifications and variations of the present invention are possible in light of the above teachings. It is therefore to be understood that, within the scope of the appended claims, the invention may be practiced otherwise than as specifically described.

1. A tillage blade comprising:
a sharpened outer peripheral edge disposed in soil for cutting through the soil for tillage purposes;
the blade having body with a body thickness (a or A), the body being operatively rotatably attached to a tillage implement about a rotational axis;
an annular portion of the blade disposed between the outer peripheral edge and the body having a thickness (b or B) which is less than the body thickness (a or A), the annular portion having a radially outer part and a radially inner part;
the blade being tapered from the sharpened peripheral edge to the radially outer part of the annular portion; and
the blade being tapered from the radially inner part of the annular portion to the body.

2. A tillage blade adapted to be rotated about a rotational axis, the blade comprising:
a main body portion having first thickness (a or A)), the main body portion being operatively rotatably attached to a tillage implement about a rotational axis;
a sharpened radially outer periphery disposed in soil for cutting through the soil for tillage purposes;
a first annular surface tapering in thickness from the outer periphery thereof to a first radius (21 or 121), the difference in radial distance from the outer periphery and the first radius (21 or 121) being a distance (c or C);
a second annular surface tapering from a second radius (22 or 122) to a third radius (23 or 123), the thickness of the blade at the third radius being approximately the thickness (a or A) of the first portion of the main body portion, the third radius (23 or 123) being less than the second radius (22 or 122);
the thickness (b or B) of the blade at the second radius (22 or 122) being less than the thickness (a or A) of the blade at the third radius (23 or 123);
the difference in radial distance from the second radius (22 or 122) and the third radius (23 or 123) being a distance (e or E); and
the thickness (b or B) of the blade at the first radius (21 or 121) being not greater than the thickness (b or B) of the blade at the second radius (22 or 122).

3. The tillage blade of claim 2 wherein the thickness (b or B) of the blade at the first radius (21 or 121) is approximately the same as the thickness of the blade at the second radius (22 or 122).

4. The tillage blade of claim 3 wherein the radial distance between the first radius (21 or 121) and the second radius (22 or 122) is a distance (d or D).

5. The tillage blade of claim 4 wherein the thickness of the blade all of the way between the first radius (21 or 121) and the second radius (22 or 122) is approximately the same.

6. The tillage blade of claim 2 wherein the thickness (b or B) equals 0.5 to 0.75 times the thickness (a or A) of the body of the blade.

7. The tillage blade of claim 2 wherein the distance (c or C) equals 1.5 to 4 times the thickness (a or A) of the body of the blade.

8. The tillage blade of claim 4 wherein the distance (d or D) equals 1 to 4 times the thickness (a or A) of the body of the blade.

9. The tillage blade of claim 2 wherein the distance (e or E) equals 2 to 4.5 times the thickness (a or A) of the body of the blade.

10. The tillage blade of claim 1 wherein the tillage blade is mounted to a grain drill.

11. The tillage blade of claim 2 wherein the tillage blade is mounted to a grain drill.
